(19) United States
(12) Patent Application Publication
(10) Pub. No.: US 2011/0243209 A1
(43) Pub. Date: Oct. 6, 2011

(54) Method device & system for receiving a communication signal

(76) Inventors: Roy Oren, Magshimim (IL); Baruch Navon, Tiberius (IL)

(21) Appl. No.: 12/929,648

(22) Filed: Feb. 7, 2011

(30) Foreign Application Priority Data
Apr. 1, 2010 (CN) 201010157114.9

(51) Int. Cl. H04B 17/00; H04L 27/06

(52) U.S. Cl. 375/227; 375/316; 375/340

(57) ABSTRACT

Disclosed is a receiver, such as an orthogonal frequency-division multiplexing (OFDM) receiver, including two or more receiver chains. Each of the receiver chain may include an antenna, down converting circuitry and time to frequency converting circuitry, and the two or more chains may be adapted to operate in concert so as to receive substantially the same signal substantially concurrently. Signal processing circuitry may be adapted to constructively combine signals received at the two or more receiver chains into a unified signal. Selection logic may be adapted to select a mode of signal combination by the signal processing circuitry, wherein the selection logic may be adapted to instruct the processing circuit to either combine two or more received signals into a single received signal or to use only one of the two or more received signals for further processing.

### CROSS REFERENCE

The present application claims the benefit of Chinese Patent Application No. 201010157114.9 filed on Apr. 1, 2010, the disclosures of which are incorporated herein by reference.

### FIELD OF THE INVENTION

The present invention relates generally to the field of communication. More specifically, the present invention relates to a method, device and system for enhancing reception of a communication signal in a wireless communication network.

### BACKGROUND

Modern communication networks are characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiFi, etc.) are used to supplement coverage for various devices (e.g. cell phone, wireless IP phone, wireless internet appliance, etc.) not physically connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively, or in any other communication system known today or to be devised in the future. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomenon, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power. The combination of attenuation, noise interference and “fading” is a substantial limitation for wireless network operators, mitigating their ability to provide high data-rate services such as Internet access and video phone services.

Some modern RF receivers may use various techniques and circuits implementing these techniques to compensate for phenomenon resulting from weak signal and interference. For example, adaptive interference (or noise) cancellers are widely used in receivers today. An adaptive noise canceller adaptively filters a noise reference input to maximally match and subtract out noise or interference from the primary (signal plus noise) input. To implement such a device one needs to have two antennae, one is used to sample the noise (aggressor), and one is used to receive the signal, which is accompanied by some amount of noise.

Antenna diversity is a scheme that uses two or more antennas to improve the quality and reliability of a wireless RF links. The concept is already in use for technologies such as WiFi, wireless microphones, and numerous other applications. The idea is to use several antennas within the receiver which receive the transmission signal through different propagation paths and to use the variations in the propagation paths in order to better reconstruct or estimate the originally transmitted signal.

There exist several techniques for receiver utilizing antenna diversity, some of which are:

Switching—In a switching scheme, the signal from only one antenna is fed to the receiver for as long as the quality of that signal remains above some prescribed threshold. If and when this signal degrades, another antenna is switched in. Switching is the easiest and least power consuming of the antenna diversity schemes, as it requires only a single receiver, but does not yield a significant improvement in reception.

Selecting—As with switching, selection processing presents only one antenna's signal to the receiver at any given time. The antenna chosen, however, is based on the best signal-to-noise ratio (SNR) among the received signals. This requires that a pre-measurement takes place and that all antennas have established connections (at least during the SNR measurement), leading to a higher power requirement. The actual selection process can take place in between received packets of information. This ensures that a single antenna connection is maintained as much as possible. Switching can then take place on a symbol-by-symbol basis if necessary, with typical switching time periods of several milliseconds.

Combining—In this scheme, all of the antennas continuously provide signal to the receiver, at all times. The signals are then “combined” and, depending on the sophistication of the system, can either be added directly (equal-gain combination—EGC) or weighted and added coherently (maximal ratio combination—MRC). Such a system provides the greatest resistance to fading, and thus the best performance, but since all the receive paths must remain energized; it also consumes the most power as it requires all the receiving paths to be active all of the time.

Signal noise and/or echo cancellation is an issue which can also be addressed using a diversity reception scheme.

There exists a need in the field of wireless communications for methods, circuits, devices and system for enhancing communication signal reception by a wireless receiver.

### SUMMARY OF THE INVENTION

The present invention is a method, circuit and system for receiving a communication signal. According to some embodiments, a receiver may be adapted to receive the same signal at two or more antennas. The receiver may determine a signal quality characteristic of received signal at each of the antennas, and based on the determination either combine the two or more received signals into a single received signal or select one of the two or more received signals for further processing.

According to further embodiments, each of the two or more received signals may be: (1) converted into a separate baseband signal; and/or (2) time domain to frequency domain transformed to each of the two separate baseband signals.

According to further embodiments of the present invention, the transformed baseband signals may be selectively combined based on a detected characteristic of one or more of the received signals. Selectively combining may include abstaining from combining in a received signal which in not synchronized with one or more other received signals.

According to further embodiments of the present invention, there may be provided a receiver including two or more receiver chains, wherein each of the receiver chains may includes an antenna and down converting circuitry. The two or more chains may be adapted to operate in concert so as to receive substantially the same signal substantially concurrently. The receiver may include signal processing circuitry adapted to constructively combine signals received at said two or more receiver chains into a unified signal and selection logic adapted to select a mode of signal combination by the signal processing circuitry, wherein the selection logic may be adapted to instruct the processing circuit to either combine two or more received signals into a single received signal or to use only one of the two or more received signals for further processing. The receiver may further include signal characterization circuitry adapted to characterize one or more signal parameters of the two or more received signals and to provide the parameters to the selection logic.

According to further embodiments of the present invention, the selection logic may be further adapted to shut down all or part of a receiver chain whose received signal is not being combined.

The receiver may be an orthogonal frequency-division multiplexing (OFDM) receiver, and may include a time to frequency domain conversion module.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a typical receive chain of a wireless receiver;

FIGS. 2, 3 and 4 show different points in which the two receive paths may be combined;

FIG. 5 shows an indication information analyzing module on each receive path;

FIG. 6 shows an indication information analyzing module on the combined signal;

FIG. 7 shows an indication information analyzing module on each receive path and on the combined signal;

FIG. 8 shows a signal to noise ratio module on each receive path and on the combined signal;

FIG. 9 shows an indication information analyzing module and a signal to noise ratio module on each receive path and on the combined signal;

FIG. 10 shows the RF unit and time domain unit of the two receive paths; and

FIG. 11 shows the RF unit and time domain unit of the two receive paths which share a single synthesizer and oscillator.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

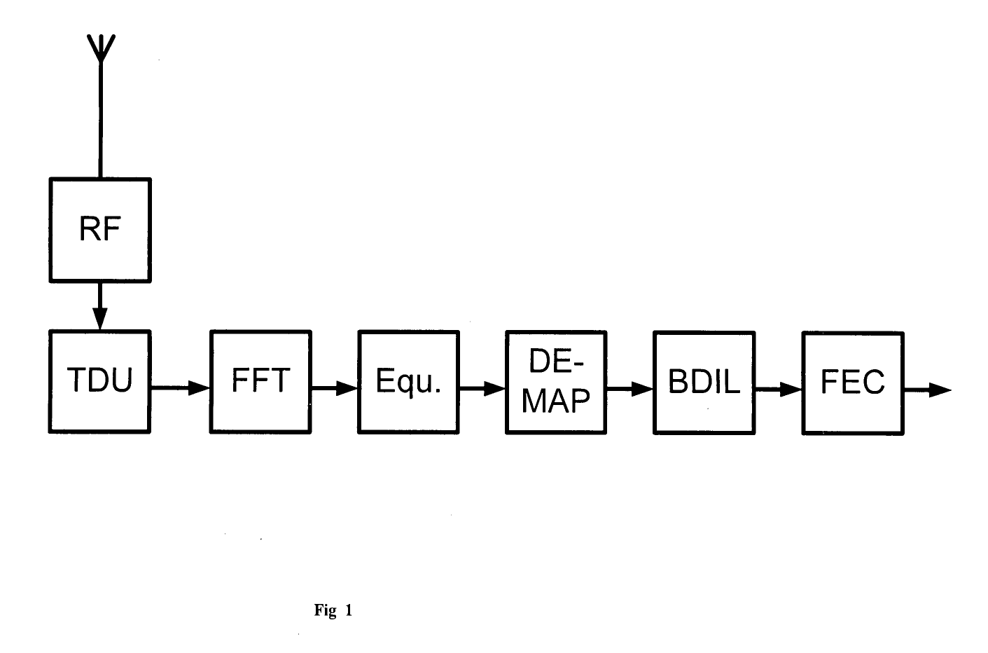

The present invention is a method circuit and system for receiving communication signal, such as an orthogonal frequency-division multiplexing (OFDM) signal. According to some embodiments of the present invention, there may be provided an RF receiver unit with two or more antennas spatially separated from one another. FIG. 1 describes an example of a receiver chain functionally associated with one of two or more antennas according to some embodiments of the present invention. The receiver chain may include: (1) an RF module which may include an RF amplifier; (2) a Time domain module (TDU), which module may include a down converter, a zero frequency amplifier, filters and other receiver circuitry; (3) a time domain to frequency domain converter module which may include a sampling module (sample and hold—S/H, analog to digital converter—A/D), and a DFT or FFT module; (4) an equalizer module for estimating the channel and reducing interference in the received signal; (5) de-mapping module (DEMAP), for extracting the soft bits from the received symbol; (6) De-interleaving module (BDIL), for rearranging the bits in their original order; and (7) forward error correction module (FEC) for correcting errors in the received data bits based on redundant bits in the data stream. According to some embodiments of the present invention, the receive chain or any part thereof may be functionally associated with the first antenna. According to some further embodiments of the present invention, a receive chain similar to that functionally associated with the first antenna, or any part thereof, may be functionally associated with a second antenna.

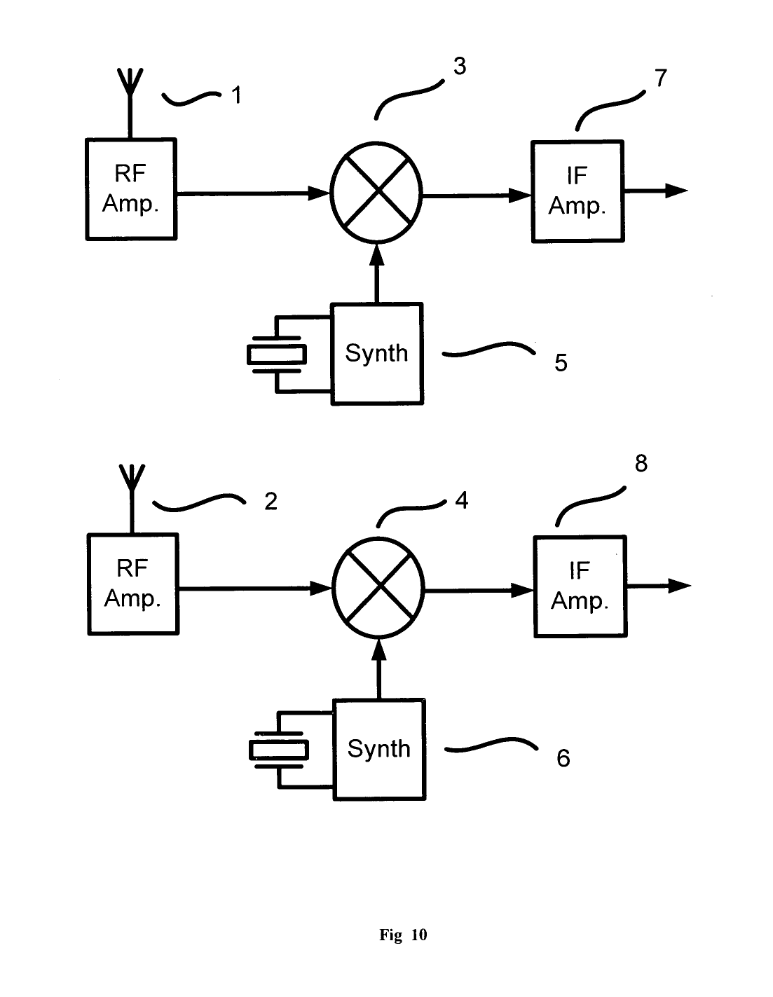

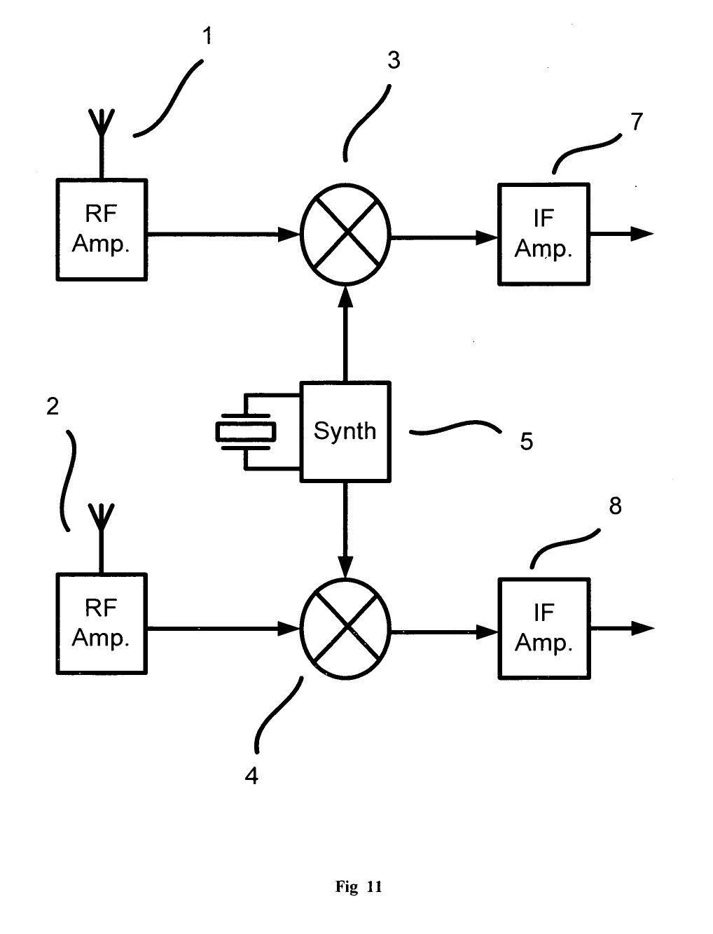

According to some embodiments of the present invention, the receive chains of the first and second antennas may have some common circuitry. FIG. 10 shows part of the time domain circuitry of the two receive paths. The first receive path may include an antenna and RF amplifier (1), a mixer (3), a synthesizer and oscillator (5), and an IF amplifier (7). The second receive path may include similar circuitry, an antenna and RF amplifier (2), a mixer (4), a synthesizer and oscillator (6), and an IF amplifier (8). According to some embodiments of the present invention, both paths may share a single synthesizer and oscillator as shown in FIG. 11. Sharing the synthesizer and oscillator may have several advantages: 1) Save the duplication of electronic circuitry; 2) Save power consumption; 3) Easier to manage one synthesizer and oscillator; 4) Both paths have the same carrier offset and timing offset and therefore the need to find the timing offset and the carrier offset for both paths can be saved, particularly in the case of a re-synchronization for one path, in which the timing and carrier offset are already known and the re-synchronized path is compensated immediately.

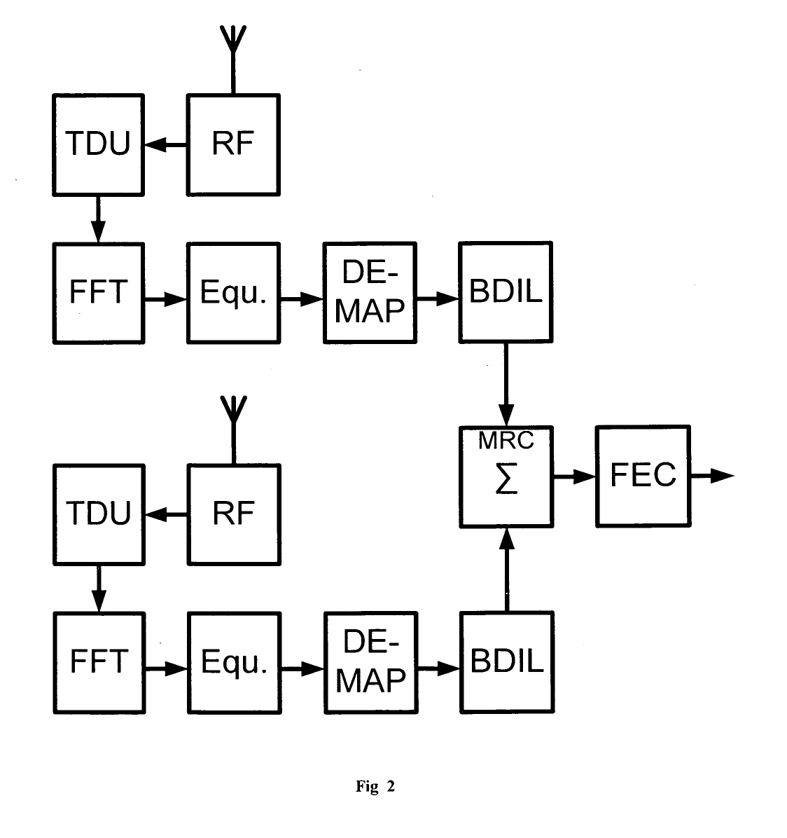

According to some embodiments of the present invention, there may be a combining module (MRC) that may combine the signals from both receive paths into a single signal. According to some other embodiments of the present invention there may be a combining module (MRC) that may select the highest quality receive path—that is the path through which a received signal has the highest S/N ratio or other signal quality characteristic. According to some other embodiments of the present invention, there may be a combining module (MRC) that may combine the signals from both receive paths into a single signal or may select the highest quality receive path. According to some embodiments of the present invention, the receive chains of the first and second antennas may be combined or selected into a single chain at different points along the respective receive chains. FIGS. 2, 3 and 4 show several examples of different embodiment of the present invention associated with different combinations/selections of the signals from the two receive chains at different points along the chain.

According to some embodiments of the present invention the two receive chains may be combined in order to improve the reception. According to some other further embodiments of the present invention, the better quality receive path may be selected exclusively. According to some other embodiments of the present invention, the two receive chains may be combined or the better quality receive path may be selected in a way that may yield the highest quality signal. According to some other embodiments of the present invention, the two receive chains may be combined or the better quality receive path may be selected in a way that may yield the highest quality signal while consuming the least power.

FIG. 2 describes an example of some embodiments according to the present invention, according to these embodiments there may be two separate receive chains that may be combined before the forward error correction (FEC) module in a way that there may be just one FEC. The combining in this case may be a simple summing of the soft bits.

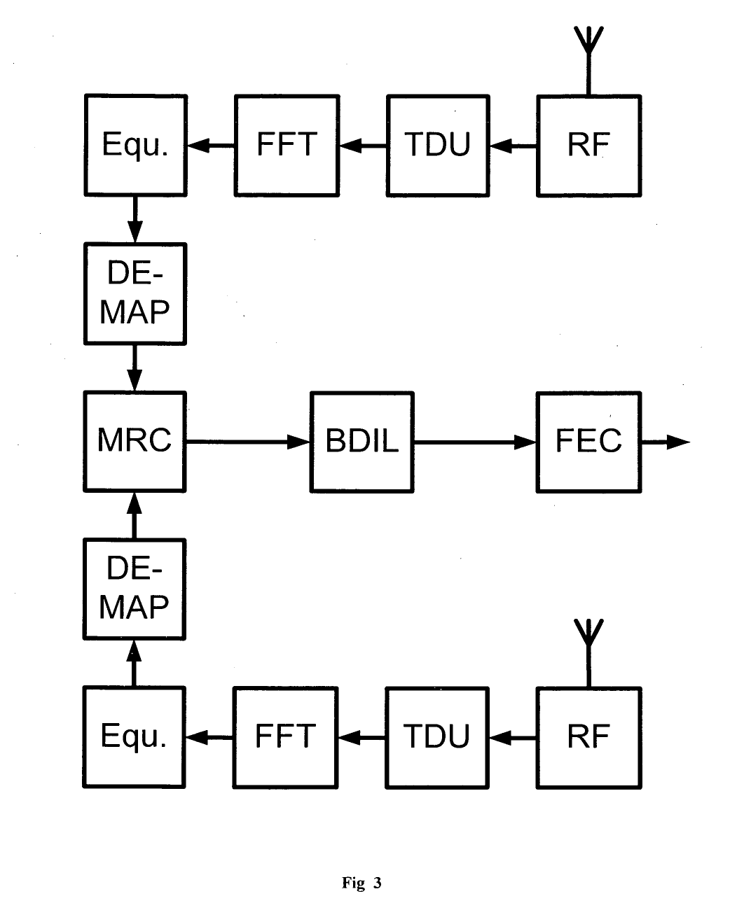

FIG. 3 describes an example of some other embodiments according to the present invention, according to these embodiments there may be two separate receive chains that may be combined before the bit de-interleaving module (BDIL) in a way that there may be just one BDIL and one FEC.

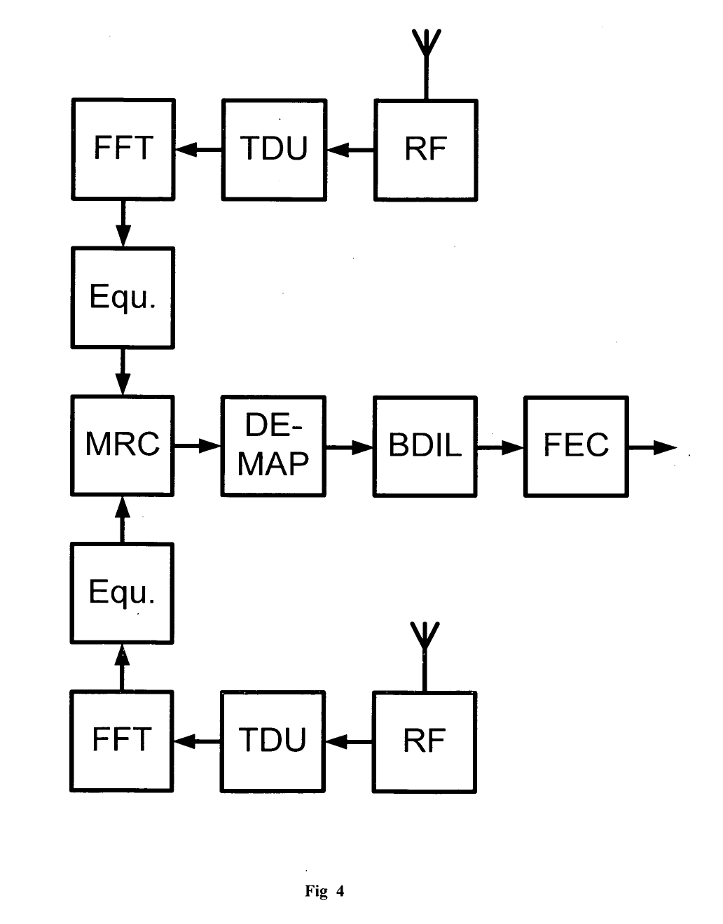

FIG. 4 describes an example of some other embodiments according to the present invention, according to these embodiments there may be two separate receive chains that may be combined before the bit de-mapping module (DEMAP) in a way that there may be just one DEMAP, one BDIL and one FEC.

In a similar way, according to some other embodiments of the present invention the combining of the receive chains may be done before the equalizer and having a single equalizer, DEMAP, BDIL and FEC.

There may be many considerations regarding the point at which it is best to combine the chains, for instance, combining the chains before the FEC requires a relatively simple electronics for simply summing the soft bits. On the other hand, by combining the chains at an earlier stage and having a single chain for both receive paths, double electronic circuitry may be eliminated, saving both cost and power.

OFDM signals include special information bits (or indication information bits) in the transmitted signal which may be used also for synchronization. The special information bits are known data bits which may be in pilot carriers, preamble or training bits, or in any other defined location in the transmitted signal. When an OFDM signal is first being acquired, there may be a synchronization phase in which the special information bits may be detected and locked on. After the completion of the synchronization phase, the receiver may be locked onto the OFDM signal and the special information bits may be tracked to verify that the receiver is still synchronized and locked onto the OFDM signal. If the receiver detects that it is out of synchronization, the synchronization phase may be repeated (re-synchronization).

According to some embodiments of the present invention, the synchronization phase or re-synchronization may be done for each receive path separately. In order to determine if a receive path is in sync, the special information bits may be extracted from that receive path by an indication information extraction module (info module). If the received signal in the received path is week, the special information bits may be detected with error by the info module and the path may be considered as being not synchronized although it is, and a resynchronization phase may be initiated unnecessarily, since when the week signals from two paths are combined together they may produce a good signal.

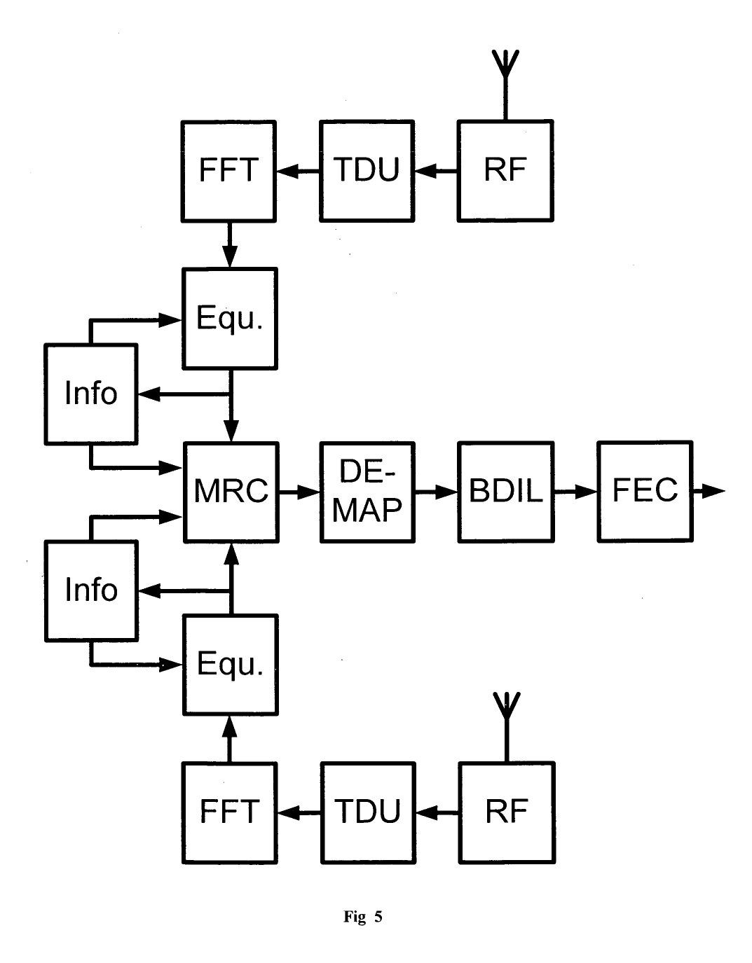

FIG. 5 shows a first info module that may receive a signal from a first receive path and a second info module that may receive a signal from a second receive path.

According to some embodiments of the present invention, the synchronization phase or re-synchronization may be done for both receive paths together. The special information bits may be extracted from the combined signals of both paths by an info module and if the combined signal is not synchronized then a synchronization or re-synchronization phase may take place for both receive paths together. This method may have two disadvantages: 1) if one receive path is out of synchronization but the combined signal is still good enough, the receive path which is not synchronized may not be re-synchronized. 2) If the combined signal is not synchronized then both receive paths will be re-synchronized although it may be that one receive path is still synchronized and does not need to be re-synchronized.

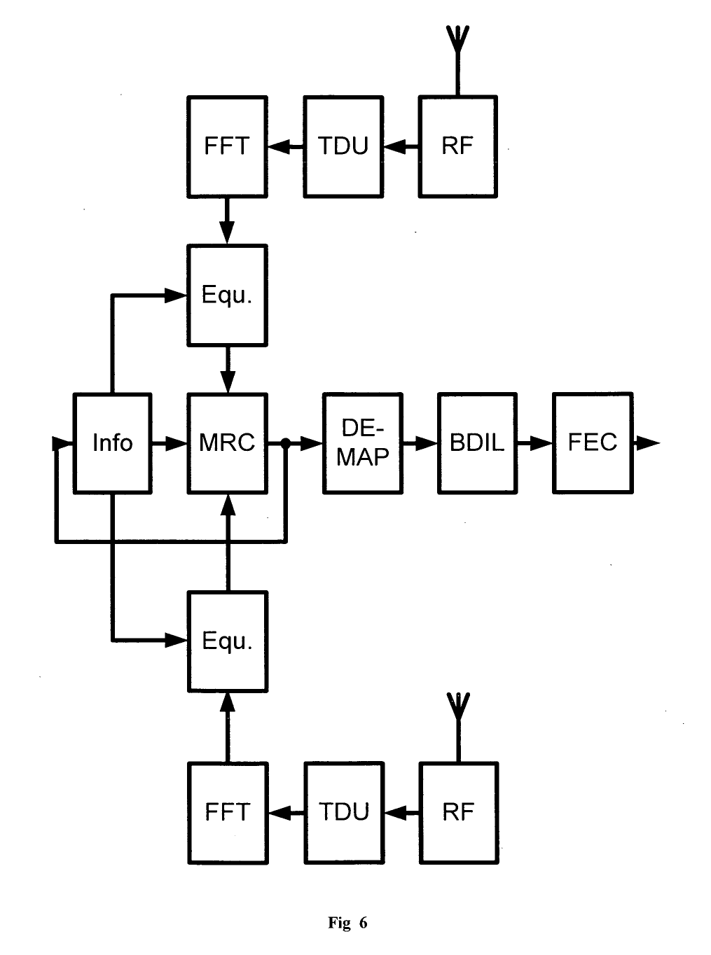

FIG. 6 shows an info module that receives the combined signal of both receive paths.

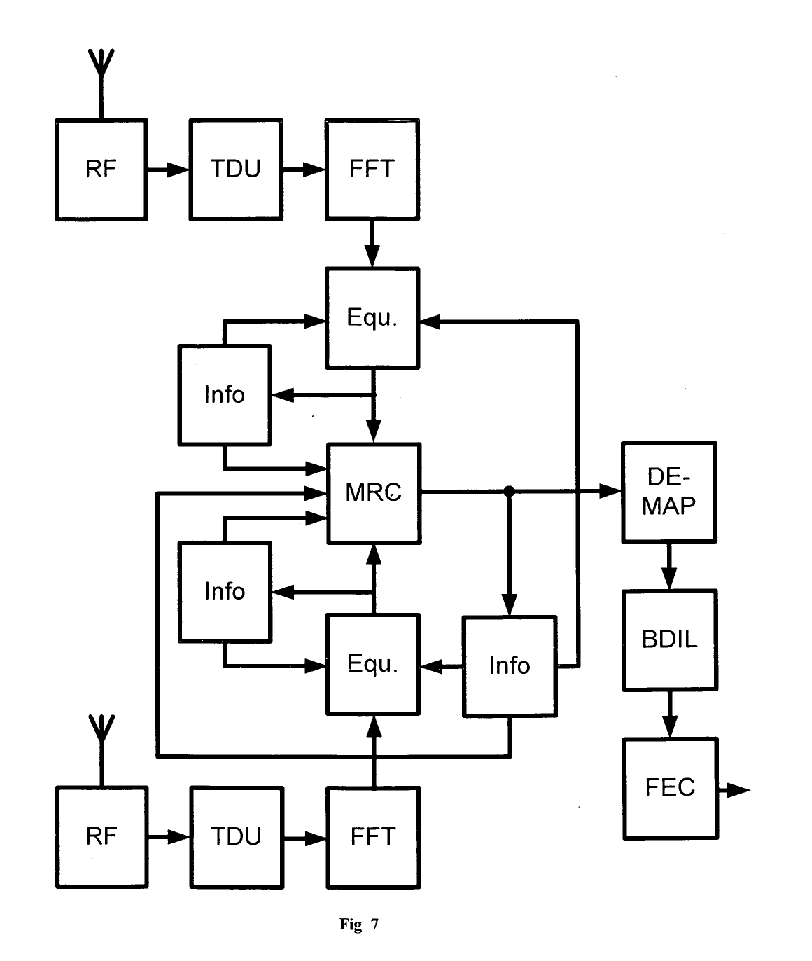

According to some embodiments of the present invention, there may be a first info module that may receive a signal from a first receive path, a second info module that may receive a signal from a second receive path, and a third info module that may receive the combined signal of both receive paths (FIG. 7). This embodiment overcomes the problems that exist in the two previous embodiments, for instance, if the first and second info modules detect that the first and second receive paths are out of synchronization, but the third info module detects that the combined signal from both paths is synchronized then non of the receive paths will be re-synchronized.

Since the info module extracts the indication information bits, it may be able to determine the quality of the signal by, for example, determining the bit error rate (BER) of the indication information bits. According to some embodiments of the present invention, the signal quality determined by the info modules may be fed to the signal combining module (MRC), which may decide whether to combine the signals from the first and second receive paths, or to use just the first or second receive path. FIGS. 5, 6, and 7 show the info modules receiving signal information and outputting signal quality information to the combining module (MRC).

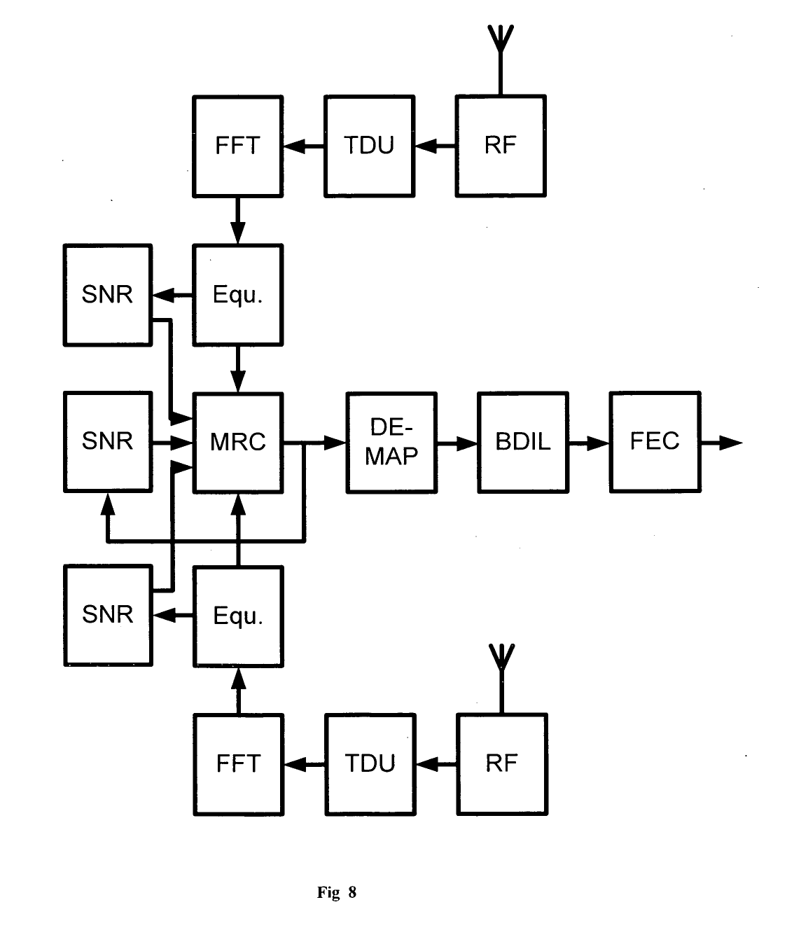

FIG. 8 shows some other embodiment according to the present invention of using signal to noise ratio meters for checking the channel signal quality. According to some embodiments of the present invention, the signal quality may be measured by a signal to noise ratio (SNR) meter. According to some embodiments of the present invention, there may be a first SNR meter associated with the first receive path, and a second SNR meter associated with the second receive path. The two SNR meters may be connected to the combining module (MRC) and provide to it the signal quality in each of the receive paths.

According to some embodiments of the present invention, there may be a first SNR meter associated with the first receive path, a second SNR meter associated with the second receive path, and a third SNR meter associated with the combined signal. The three SNR meters may be connected to the combining module (MRC) and provide to it the signal quality in each of the receive paths and in the combined signal. According to some embodiments of the present invention, the combining module may decide according to the information provided to it by the SNR meters if to combine the two receive paths or to use just one receive path. For instance, if both receive paths have a high quality signal the combining module may use just one path in order to save power. Another reason may be a case in which one receive path has a high quality signal and the other path has a poor signal which has a negligible contribution to the combined signal, in this case the combining module may select just the high quality signal.

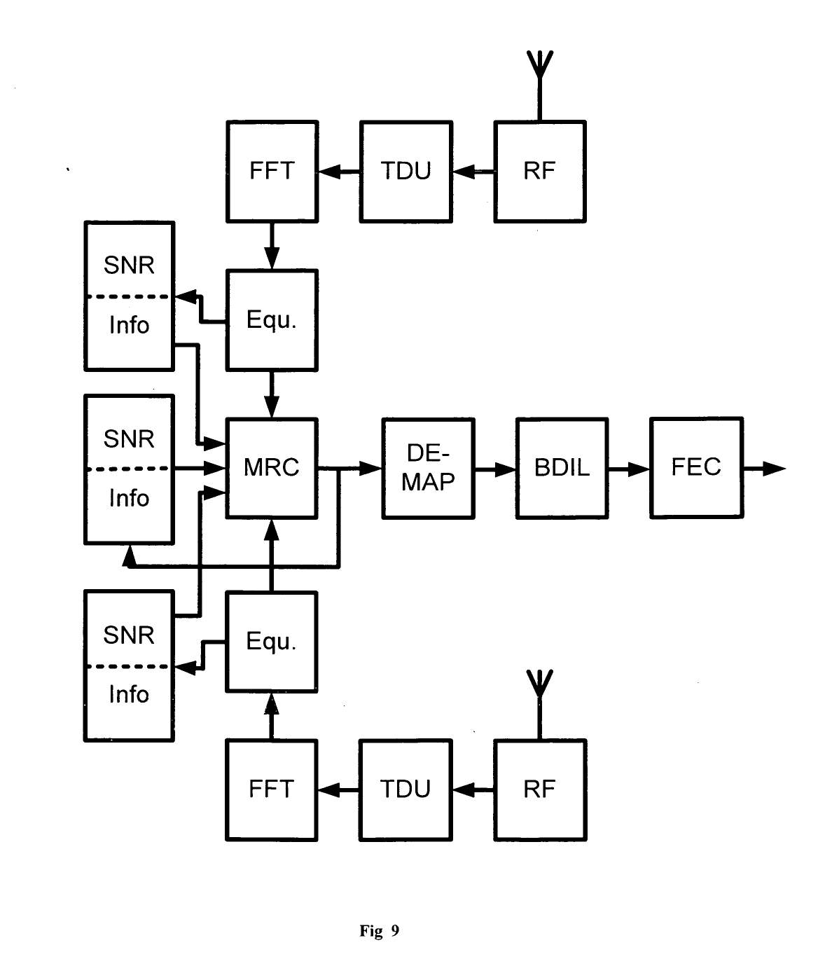

According to some embodiments of the present invention, there may be an info module and a SNR meter associated with the first receive path, and an info module and a SNR meter associated with the second receive path and optionally an info module and/or a SNR meter associated with the combined signal (FIG. 9). The info modules and SNR meters associated with the first and second receive paths, and the info module and/or SNR meter associated with the combined signal may provide signal quality, information and/or synchronization information to the combining module (MRC). According to some embodiments of the present invention, the combining module (MRC) may receive signal quality information and/or synchronization information from the info modules and/or SNR meters and based on this information may combine the signals from the first and second receive paths or use the signal from just one receive path.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of receiving an signal comprising:
receiving the same signal at two or more antennas;
determining a signal quality characteristic of received signal at each of the antennas; and
based on the determination either combining the two or more received signals into a single received signal or selecting one of the two or more received signals for further processing.

2. The method according to claim 1, wherein the two or more signals are combined after their respective time to frequency conversion.

3. The method according to claim 1, wherein the two or more signals are combined after their respective de-mapping.

4. The method according to claim 1, wherein the two or more signals are combined after their respective equalization.

5. The method according to claim 1, further comprising converting each of the two or more received signals into a separate baseband signal prior to combing them.

6. The method according to claim 1, further comprising applying a time domain to frequency domain transform to each of the two separate baseband signals.

7. The method according to claim 1, further comprising selectively combining the received signals based on a detected characteristic of one or more of the received signals.

8. The method according to claim 7, wherein signal characteristic detection is performed on each of the respective received signal paths.

9. The method according to claim 8, wherein signal characteristic detection is performed on the combined signal.

10. The method according to claim 7, wherein selectively combining comprises abstaining from combining in a received signal which in not synchronized with one or more other received signals.

11. A receiver comprising:
two or more receiver chains, wherein each receiver chain includes an antenna and down converting circuitry, and wherein said two or more chains are adapted to operate in concert so as to receive substantially the same signal substantially concurrently;
signal processing circuitry adapted to constructively combine signals received at said two or more receiver chains into a unified signal; and
selection logic adapted to select a mode of signal combination by the signal processing circuitry, wherein said selection logic is adapted to instruct the processing circuit to either combine two or more received signals into a single received signal or to use only one of the two or more received signals for further processing.

12. The receiver according to claim 11, further comprising signal characterization circuitry adapted to characterize one or more signal parameters of the two or more received signals and to provide the parameters to the selection logic.

13. The receiver according to claim 12, wherein signal characterization circuitry is adapted to characterize one or more signal parameters of each of the two or more received signals.

14. The receiver according to claim 13, wherein signal characterization circuitry is adapted to characterize a combined signal.

15. The receiver according to claim 11, wherein said selection logic is further adapted to shut down all or part of a receiver chain whose received signal is not being combined.

16. The receiver according to claim 11, wherein the receiver is an orthogonal frequency-division multiplexing (OFDM) receiver.

17. The receiver according to claim 16, further comprising a time to frequency domain conversion module.

18. An orthogonal frequency-division multiplexing (OFDM) receiver comprising:
two or more OFDM receiver chains, wherein each receiver chain includes an antenna, down converting circuitry and time to frequency converting circuitry, and wherein said two or more chains are adapted to operate in concert so as to receive substantially the same OFDM signal substantially concurrently;
signal processing circuitry adapted to constructively combine signals received at said two or more receiver chains into a unified signal; and
selection logic adapted to select a mode of signal combination by the signal processing circuitry, wherein said selection logic is adapted to instruct the processing circuit to either combine two or more received signals into a single received signal or to use only one of the two or more received signals for further processing.

19. The receiver according to claim 18, further comprising signal characterization circuitry adapted to characterize one or more signal parameters of the two or more received signals and to provide the parameters to the selection logic.

20. The receiver according to claim 18, wherein said selection logic is further adapted to shut down all or part of a receiver chain whose received signal is not being combined.
